(19) United States
(12) Patent Application Publication
(10) Pub. No.: US 2007/0185796 A1
(43) Pub. Date: Aug. 9, 2007

(54) Virtual folders for financial accounts

(76) Inventors: Lori Frances Kingshott, Danville, CA (US); Julie Ann Tone, Fresno, CA (US)

Correspondence Address: Lori Kingshott, 805 Waingarth Way, Danville, CA, 94526, US

(21) Appl. No.: 11/183,321

(22) Filed: Jul. 18, 2005

(51) Int. Cl. G06Q 40/00

(52) U.S. Cl. 705/36 R

(57) ABSTRACT

Virtual folders for financial and asset accounts, which enable users to organize and manage account finances and assets according to source, purpose and disposition.

### CROSS-REFERENCE TO RELATED APPLICATIONS

Not applicable.

### BACKGROUND

1. Field of Invention

This invention is applicable in the banking, finance and money management fields and relates to financial account organization and management for users and service providers.

2. Description of Prior Art

In U.S. Pat. No. 4,948,174, Thomson et al. described a financial data processing system for affecting the accounting functions of debiting and crediting a bank's account records. This patent is a processing system and does not describe a method of segregating, manipulating and displaying financial information.

In U.S. Pat. No. 6,304,860 Martin, Jr. et al. described an automated debt payment system and method using the ATM network. This patent is a payment system and does not describe a method of segregating, manipulating and displaying financial information.

Financial and money management organizations provide services to consumers and businesses and strive to meet all of the finance and portfolio management needs of these groups.

In the asset management category of services provided by a bank or financial institution, consumers and businesses have one or more accounts. Deposits accumulate in the account and withdrawals and payments to third parties are debited.

The service providers provide several choices to consumers and businesses for the interface to the management of the account. Customers can carry out account management by: a) entering a bank and carrying out transactions with the aid of a teller or other bank employee b) carrying out transactions at an ATM c) calling the bank's Integrated Response Unit or d) accessing the service provider's website.

As financial portfolio management currently exists, users would create separate accounts in order to segregate funds and debits for specific purposes. This current process involves a lot of unnecessary paperwork and in some cases fees; in order to set aside assets for specific purposes in a separate and organized manner, a consumer or business would have multiple accounts or have a tracking system that is independent and not integrated with the banking or financial systems.

### SUMMARY

This invention is a virtual folder structure for financial accounts. The invention would enable users and service providers to manage and organize their assets.

### OBJECTS AND ADVANTAGES

The objects and advantages of virtual folders for asset or bank accounts are:
(a) To have fewer bank accounts to manage as the necessary management functions can be carried out with the use of the folder structure
(b) To better manage a specific asset account or bank account
(c) To organize deposits and debits, as each folder would relate to a specific goal or purpose
(d) To share a single bank account among a group or family and retain the service provider conferred benefits of the aggregate financial sum
(e) To provide account asset management through the use of user-defined specifications that can be customized by the user of the service provider system

### DESCRIPTION

The design of the Virtual Folders for Financial Accounts structure follows the same principles as file folders on a drive of a computer. It is a method of segregating assets in an account so that a user can track specific funds and debits without the needs to create separate accounts. This application of the folder methodology for organization of assets differs from the file folder structure on a computer. Specifically, the folder structure would augment the current account structure that is administered by the service provider or financial institution.

Within the current Account Management System, the service provider would add the capability to support a number of folders within accounts. Additionally, the service provider would implement the applications so that the assets within a folder can be managed with the new folder structure. Enhanced capabilities of the system would include: a) direction of assets from specific sources to specific folder locations within the account structure b) disbursement of assets from specific virtual folders for specific payments and c) movement and tracking of funds within folders and between accounts. would be offered to users as a value add service or as a for-fee service.

Users of the Virtual Folders for Financial Accounts would design their account folder structure to meet their asset management goals. FIG. 1 shows an example of the virtual folder structure for a set of specific bank accounts for a theoretical user. Users specify the rules for treatment of funds within folders and between accounts, within the constraints of the service provider system capability. The interfaces provided to the user for this design of the folder structure and asset treatment and disposition, can be any of the traditional or new methods of access, including but not limited to the following: a) entering a bank and carrying out transactions with the aid of a teller or other bank employee b) carrying out transactions at an ATM c) calling the bank's Integrated Response Unit or d) accessing the service provider's website.

Assets and the specific folder to which those assets are to be assigned are identified and the assets are allocated to the appropriate folder, as specified by the user. Additionally, rules and customization designed by the user may provide additional detail regarding the direction of the assets. Correspondingly, funds to be paid from a specific folder are identified and the assets are disbursed from the appropriate folder, based on the user design and specifications.

### ADDITIONAL EMBODIMENTS

1) Rules or treatments of funds within folders can be specified by the user.

2) Constraints or guidelines can be specified by the service provider.

3) Subfolders within folders could be added as an additional level of customization

### EXPLANATION OF FIGURES

FIG. 1: Device for generating virtual folders.

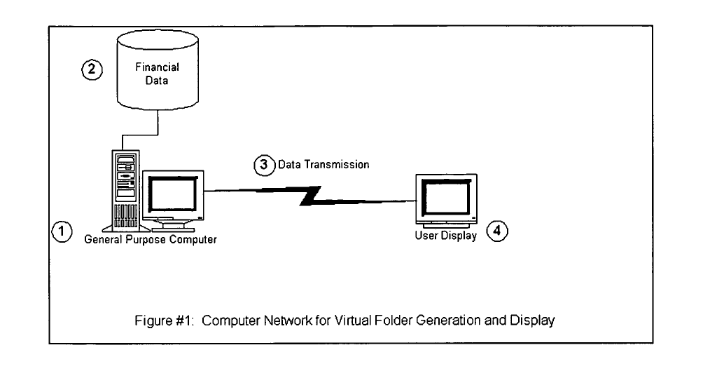

A general-purpose computer (1) obtains and stores financial records for users in a database (2). The general-purpose computer contains and generates logic for a display (4) that may be separate from the general-purpose computer. The logic is transmitted to the display (4) by a physical or logical data transmission network (3). On the display (4), the virtual folders are displayed to the user.

FIG. 2: Example of virtual financial folders.

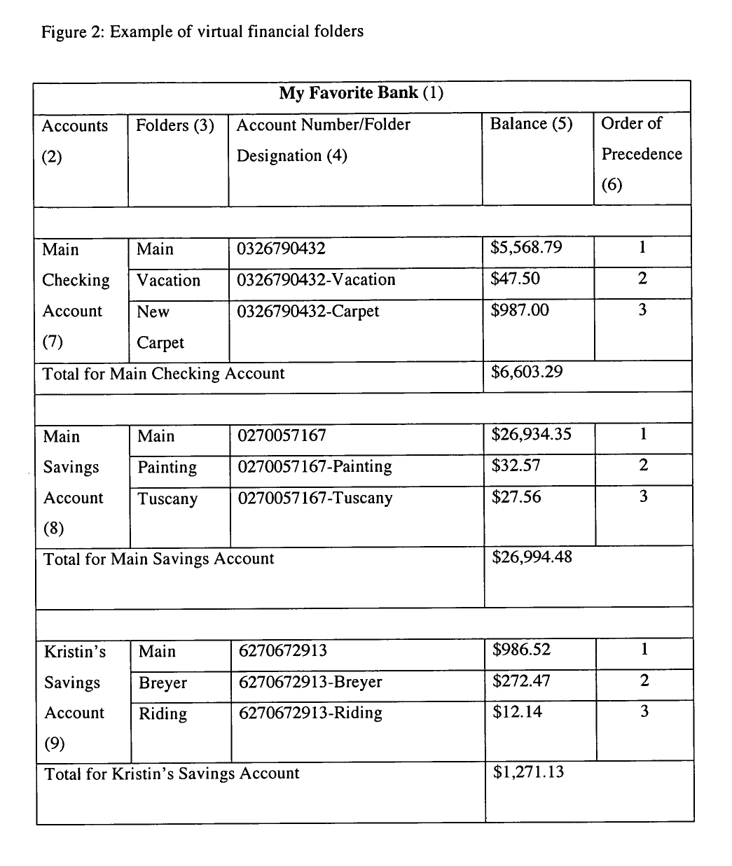

The virtual folder for a bank (1) sets up a structure for organizing accounts (2), folders (3), account number/folder designation (4), balance (5) and order of precedence (6). The client interacts with the bank (1) to set up a number of accounts (2) such as (7), (8) and (9). Within each account (2), the user can specify a number of folders, which have the account number/folder designation (3). Each folder (3) will have a unique identifier (4), corresponding balance (5), and order of precedence (6). Transactions will apply to a specific balance (5) in a specific folder (3).

### CONCLUSION, RAMIFICATIONS AND SCOPE

Accordingly, the reader will see that the virtual folder structure for financial accounts will provide consumers and businesses with an organizational and management capability that will provide a function that they desire.

Specific advantages of the virtual folders for bank account include the following:
A folder within a single account can be used to track balances that can be related to a specific source of funds
A folder within a single account can be used to track balances that can be related to savings for a specific purpose
A folder within a single account can be used to track balances that can be related to a specific individual within a family or other group that shares resources
A single account with folders may qualify for better bank rates and services as the finances of multiple accounts would be aggregated

Although the description above contains specificities, these should not be construed as limiting the scope of the invention but as merely providing illustrations of some of the presently preferred embodiments of this invention. For example, the account could be a stock or bond portfolio with virtual folders.

Thus the scope of the invention should be determined by the appended claims and their legal equivalents, rather than by the examples given.

1. A method of structuring, segregating and indicating user-specified groups within an existing financial or asset account structure, comprising:
(a) first, novel means for segregating the funds into separate groups
(b) second, novel means for displaying the structure of the said separate groups
(c) third, novel means of displaying the quantity of funds in the said separate groups
(d) fourth, novel means of specifying the relationships between the said separate groups
(e) fifth, novel means for the management of finances and assets between the said separate groups
(f) sixth, novel means for integrating or incorporating transactions originating or terminating external to the system, into the said separate groups
